(19) United States
(12) Patent Application Publication
(10) Pub. No.: US 2025/0058411 A1
(43) Pub. Date: Feb. 20, 2025

(54) CUTTING DEVICE AND METHOD FOR MANUFACTURING A CONTAINER

(71) Applicant: ALPLA Werke Alwin Lehner GmbH & Co. KG, Hard (AT)

(72) Inventors: Alexander SOHM, Dornbirn (AT); Manuel FÄSSLER, Lustenau (AT); Simon SEPPI, Hohenems (AT)

(73) Assignee: ALPLA Werke Alwin Lehner GmbH & Co. KG, Hard (AT)

(21) Appl. No.: 18/722,215

(22) PCT Filed: Dec. 20, 2022
(86) PCT No.: PCT/EP2022/086869

§ 371 Date: Jun. 20, 2024

(30) Foreign Application Priority Data
Dec. 21, 2021 (CH) 070758/2021

(51) Int. Cl. B23K 26/10; B23K 101/12; B23K 103/16

(52) U.S. Cl. CPC B23K 26/103; B23K 2101/12; B23K 2103/16

(57) ABSTRACT

Disclosed is a cutting device (100) and a method for manufacturing a fiber-based container (10). The cutting device (100) has a holding device (50) for holding the fiber-based container (10) and a cutting laser (20) for generating a laser beam (21). The laser beam (21) of the cutting laser (20) and the fiber-based container (10) can be moved relative to one another by means of the laser beam (21) in order to separate an excess projection (11) of the fiber-based container (10).

The present invention relates to a cutting device and to a method for manufacturing a container according to the preamble of the independent claims.

Different containers for holding liquid are known from the prior art. For example, glass bottles or plastic bottles for holding beverages have become established. Containers which are made of fiber-based material have likewise already been proposed.

A fiber-based container was proposed in WO 2012/139590 A1. To produce this container, what is known as pulp is introduced into a mold and within this mold pressed with a flexible balloon against a corresponding wall and compressed accordingly.

Pulp is a mixture of fibers and water, in particular natural fibers such as hemp fibers, cellulose fibers or flax fibers or a mixture thereof. The pulp may contain additives, as known, for example, from WO 2020/070255 A1, which, for example, improve curing of the compressed pulp or have an influence on the later appearance or generally change the properties of the pulp or of the later container.

In these containers, there is a risk of them softening due to liquid stored in the container and, for example, becoming leaky or of substances diffusing out of the container into the liquid.

It has been proposed to provide such fiber-based containers with an inner layer made of plastic, in particular to arrange within the fiber-based container a plastic bottle which can assume corresponding barrier functions. The fiber-based container thus only provides a shell for a thin-walled plastic container. Such a combination has become known from WO 2018/167192 A1.

It is known that certain inaccuracies can arise during production not only in the case of fiber-based containers provided with an inner plastics layer in a further method step, that is to say in fiber-based shells, but also in the case of fiber-based containers provided with no such layer. Since the containers and/or shells are formed in a negative mold, a very high dimensional fidelity can be achieved in relation to their outer contour. Depending on the specific properties of the pulp from which the container/shell is formed, the inner contour or the inner surface of the container/shell is subject to differently sized deviations. These are typically negligible with the exception of deviations in the region of an opening of the container into which a plastics container is later introduced and/or on which a container closure is arranged, or which is designed as a container neck having corresponding fastening elements for a container closure. As a result of the material properties of the pulp, an upper, final edge of the opening is subject to greater tolerances and is often fibrous. This is disadvantageous, in particular, since this forms an interface to the already mentioned plastic containers and/or container closures and this interface must be designed to be dimensionally accurate.

Various attempts have been made to manufacture this edge of the opening, for example by cutting off excess material. This has led to an improvement and is suitable, for example, for containers into which a separate inner shell is inserted, for example in the form of a preform. This is still too imprecise for fiber-based containers that have a neck and fastening elements arranged thereon intended to interact with a container closure. For such containers, a sealing effect must be ensured between the opening and the container closure.

The object of the invention is to eliminate at least one or more disadvantages of the prior art. In particular, a cutting device and/or a method is to be provided which make it possible to manufacture fiber-based containers with precise dimensions and, in particular, to provide a high-quality cut in a manner that is as independent as possible of differences in material of the container. It is preferable to avoid any post-processing of the cut.

This object is achieved by the devices and methods defined in the independent claims. Further embodiments result from the dependent claims.

A cutting device according to the invention for manufacturing a fiber-based container has a holding device for holding the fiber-based container. Said device also has a cutting laser for generating a laser beam, wherein the laser beam of the cutting laser and the fiber-based container can be moved relative to one another in order to separate an excess projection of the fiber-based container by means of the laser beam.

The fiber-based container is preferably a beverage bottle.

By providing a laser, or a laser beam, to separate the projection, a very precise cutting edge can be formed.

The relative movement of the laser beam in relation to the fiber-based container makes it possible to move the laser beam at a constant distance from the surface of the projection to be separated and also to maintain a specific angle between the laser beam and the surface. In other words, this configuration allows an angle of the cutting edge along the surface to be kept the same over the entire length of the cutting edge. This also results in a very flat cutting edge. Waviness of the cutting edge can be prevented.

The relative movement is preferably a rotational movement of the laser beam in relation to the container, i.e. a movement of the laser beam in the circumferential direction of the container.

It can be provided that the cutting device has a rotary bearing, wherein a deflection device for guiding the laser beam is arranged on the rotary bearing. The deflection device is preferably rotatable about a longitudinal axis of the fiber-based container.

The longitudinal axis of a fiber-based container is defined by its extension from the bottom of the container to the opening of the container. The bottom of the container forms a base for the container. The longitudinal axis typically also corresponds to the pouring direction and, in the case of rotationally symmetrical bottles, to the axis of rotation.

In other words, an element attached to the rotary bearing rotates about the central axis or center axis of a bottle, or of a fiber-based container, and, should the opening not be in the center of the bottle, about the center axis of the opening.

In particular in the case of rotationally symmetrical containers, such an arrangement makes it easier to guide the laser beam and to maintain a specific distance from the surface of the projection to be separated.

The deflection device also makes it possible to direct the laser beam in a specific path and/or to guide it around obstacles that may be in the direct path of the laser beam.

The deflection device makes it possible in particular to introduce the laser beam centrally, for example in the direction of the longitudinal axis, and to deflect it in such a way that it impinges on the surface of the projection to be separated substantially at a right angle or, if desired, at any angle—with an accuracy of +/−1° or less to the longitudinal axis.

The cutting device can have focusing optics for focusing the laser beam. This focusing optics is in particular an integral part of the deflection device.

The focusing optics makes it possible to precisely align the laser beam on a surface of the projection to be separated; in other words, to provide a focal point of the laser beam that is at a specific distance from the surface of the projection to be separated. This distance is not present for small wall thicknesses of preferably less than 1 mm, i.e. 0 mm. For thick walls, the distance can be negative; in other words the focal point is then within the wall thickness.

Such an arrangement can produce an even and clean cut. It also ensures that the laser beam only has its maximum power at its focal point and is harmless to surrounding elements at a distance therefrom.

By designing the focusing optics as an integral part of the deflection device, said optics can be moved together with the deflection device and can accordingly be attached to the rotary bearing together with the deflection device so that the focusing optics can be moved on a circular path around the fiber-based container.

The focusing optics can be arranged substantially at an angle of 85° to 95°, in particular at an angle of 89° to 91°, preferably perpendicularly to the longitudinal axis, and radially spaced therefrom.

This results in the focusing optics being arranged substantially vertically and at a constant distance from a surface of a projection to be separated, provided that the projection is substantially cylindrical.

Alternative arrangements so that the laser beam is at an angle are also possible. This can result in a cutting edge that is inclined inward or outward for example, if this is desired.

A radial distance between the focusing optics and the longitudinal axis is preferably adjustable, in particular continuously adjustable.

This also makes it possible to process containers that do not have a rotationally symmetrical cross section in the region of the projection to be separated, but instead have an oval or polygonal cross section, for example.

During the rotary movement of the deflection device, the distance of the focusing optics is adjustable so that, for example, an elliptical path is also possible instead of a circular path.

It is conceivable that a corresponding, previously recorded profile is transferred to the cutting device so that a radial adjustment of the focusing optics is continuously adapted according to the profile over the length of the cut. This ensures a continuous adjustment of the radial distance, which allows the distance between the focusing optics and thus the focal point of the laser beam and the surface of the projection to be separated to remain the same over the entire length of the cut.

It would also be conceivable that, if the surface is uneven or has unknown contours, for example, this is measured almost in real time and the radial distance of the focusing optics is continuously adjusted.

The cutting device can have an outlet nozzle through which the laser beam is guided.

On the one hand, this protects the laser beam, and on the other hand, an outlet nozzle also allows for the introduction of a process gas, for example.

The deflection device of the cutting device can have a plurality of deflection mirrors. Deflection mirrors make it possible to easily deflect the laser beam.

The deflection device preferably has a safety element downstream of each deflection mirror in the direction of incidence, or a safety element is arranged at an appropriate location.

This prevents the uncontrolled escape of the laser beam if, for example, one of the deflection mirrors fails, for example breaks.

The safety elements can, for example, be designed as metal plates, in particular as steel plates.

The deflection device is preferably designed as a substantially closed system of individual tubes. Due to the tubular construction, the interior of the deflection device is at least partially shielded from the outside world and the entrance of dust or foreign bodies into the beam path of the laser beam can be reliably prevented.

It can be provided that a first suction device for extracting vapors and/or dirt is arranged on the cutting device, in particular on the rotary bearing, wherein the first suction device ends in particular in the region of the outlet nozzle.

Dirt, dust or particles that form during the cutting process can thus be extracted. Vapors that may in some cases be harmful to health can also be extracted in this way.

It can be provided that a flushing device for flushing the interior or the inside of the container with a flushing gas is arranged on the cutting device, in particular on the rotary bearing.

During operation, the laser beam typically impinges on the surface of the projection to be separated from the outside. Dirt or particles that arise during the cutting process are thus transported toward the interior of the fiber-based container. By introducing flushing gas into the interior of the container, this can be counteracted and the particles that form can be blown out of the container.

Additionally or alternatively, it can be provided that the cutting device has a second suction device for extracting the flushing gas from the interior of the container. Preferably, the second suction device is designed in particular as part of the flushing device.

The particles or gases transported by the flushing gas out of the interior of the container can accordingly be directly extracted using the second suction device. The provision of a second suction device also promotes the formation of specific flow conditions in the interior of the container.

Designing said second suction device as an integral part of the flushing device makes it possible to move it together with the flushing device into the interior of the container or to remove it from the interior of the container after the cutting process has been completed.

The holding device for holding the fiber-based container can have two grippers. Accordingly, the fiber-based container can be held symmetrically from two sides.

The deflection device is preferably vertically adjustable along the longitudinal axis. This design makes it possible to hold the fiber-based container statically at a certain location and to guide the deflection device to the appropriate position for processing purposes, i.e. for separating the projection, without the container fixed in the holding device or its position having to be adjusted.

A further aspect relates to a method for manufacturing a fiber-based container having a cutting device, in particular having a cutting device as described here. The method comprises the steps of:
Providing a fiber-based container in a holding device,
Providing a laser beam of a cutting laser,
Separating an excess projection of the fiber-based container by means of the laser beam,
   wherein the fiber-based container and the laser beam are moved relative to one another in order to separate the excess projection.

The relative movement between the laser beam and the fiber-based container makes it possible to move the laser beam such that it maintains a constant distance in relation to the surface of the projection to be separated and also to maintain a specific angle between the laser beam and the surface.

It can be provided that the laser beam is guided in a deflection device and that this deflection device is rotated about a longitudinal axis of the fiber-based container so as to generate the relative movement in order to separate the excess projection.

Such a method step can provide a simple method sequence that is precisely adjustable and reproducible.

The laser beam can be focused on a surface of the projection to be separated by means of focusing optics, or the focus of the laser beam is adjustable to a specific distance from the surface. This can be zero or negative so that the focal point comes to lie within the material thickness.

A clean cut can be made possible using such focusing optics and appropriate focusing.

To make the cut, the laser beam can be positioned and activated above a final cutting surface in the direction of the longitudinal axis. The laser cut has a vertical movement component up to a cutting position of the final cutting surface.

In particular, this vertical movement component is also superimposed with a movement component directed in the circumferential direction of the fiber-based container so that a substantially grinding cut is created.

By positioning and activating the laser beam above the final cutting surface, defects that arise when the laser beam is activated can be prevented. Typically, more energy is introduced when the laser beam first passes through the object to be separated, resulting in burning of the object to be separated at certain points. By positioning the laser beam above the final cutting surface, this burning at certain points is not in the region of the final cutting surface.

Preferably, after completion of the cut of the final cutting surface, the laser beam is moved over the final cutting surface in the direction of the longitudinal axis before deactivating the laser beam. The laser cut has a vertical movement component up to the final position in which the laser beam is deactivated.

Just as at the beginning of the cut, there is sometimes also an increased energy input at the end of the cut and burn marks may form. The vertical movement component allows the burn mark to be kept away from the final cutting surface.

Preferably, the vertical movement component also has a superimposed movement component directed in the circumferential direction of the fiber-based container in this case. Here, too, a grinding cut is created.

Both switching on and off of the laser beam can occur while the laser is moving downward or upward, and the container and the laser beam also already have the movement component directed in the circumferential direction of the fiber-based container. This also reduces the risk or at least the degree of burning at certain points.

Preferably, a radial distance between the focusing optics and the longitudinal axis is initially adjusted according to a container-specific parameter. This ensures that a focal point of the laser beam is always at the desired distance from the surface of the projection to be separated, thus creating a cutting surface with correspondingly high quality.

The container-specific parameter can be determined individually for each fiber-based container. It is conceivable that each container is measured before the cutting process and the corresponding data are transferred to the cutting device, which accordingly performs the cut with a static adjustment.

For example, this parameter can also be adjusted for entire batches, for example if they are manufactured within a narrow tolerance range.

In other words, a previously recorded profile can be transferred to the cutting device so that a radial adjustment of the focusing optics can be continuously adapted according to the profile over the length of the cut.

However, it is also conceivable that the radial distance is continuously adapted to a contour of the fiber-based container during the separation or cutting process.

This ensures a continuous adjustment of the radial distance, which allows the distance between the focusing optics and thus the focal point of the laser beam and the surface of the projection to be separated to remain the same over the entire length of the cut.

It would also be conceivable that, if the surface is uneven or has unknown contours, for example, this is measured almost in real time and the radial distance of the focusing optics is continuously adjusted.

To improve the quality of the cutting edge, flushing gas can be blown into the fiber-based container during the cutting process using a flushing device. By blowing flushing gas in in this way, dirt and particles that arise during the cutting process can be blown out of the interior of the container or are prevented from settling inside the container.

Additionally or alternatively, it can be provided that during the separation process, exhaust air is extracted from the fiber-based container, in particular from the interior of the fiber-based container, by a second suction device and/or from the region of an outlet nozzle by a first suction device.

This contributes to an improvement in cutting quality and subsequent cleaning of the cutting edge can be omitted.

Additionally or alternatively, it can be provided that the deflection device is supplied with flushing gas during the separation process.

On the one hand, this prevents dust or dirt particles from depositing and/or settling in the deflection device and in particular on deflection mirrors arranged therein or thereon. On the other hand, by supplying the deflection device with flushing gas at an outlet nozzle, a protective gas flow can be generated which provides protection against external influences in the region of the cut. Such a protective gas flow can in particular prevent dirt or dust particles from entering the laser beam.

After the separation process, the separated excess projection can be stripped off the cutting device by means of a stripping ring from the cutting device.

The excess projection can thus be specifically disposed of, for example by being transported toward a separate funnel or container.

The invention will be explained below with reference to drawings. In the drawings:

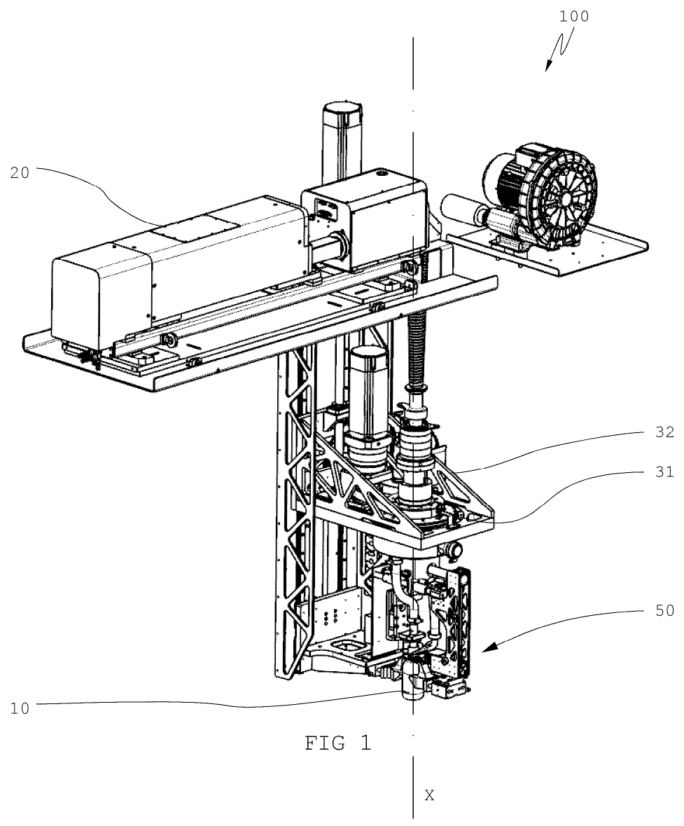

FIG. 1: is a perspective view of a cutting device;

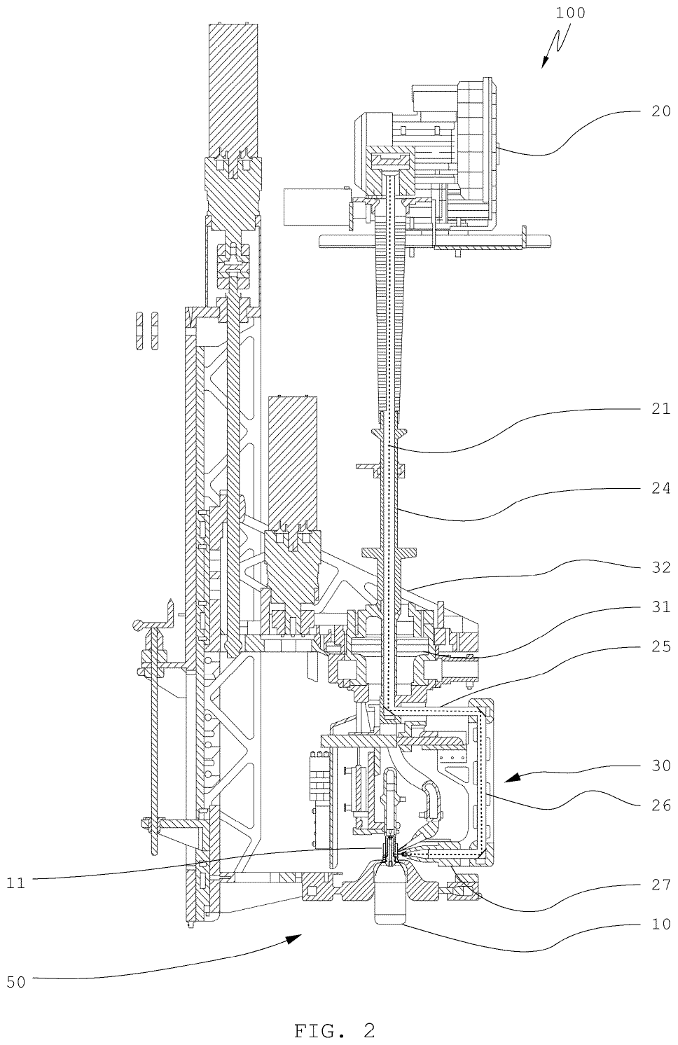

FIG. 2: is a sectional view through the cutting device according to FIG. 1;

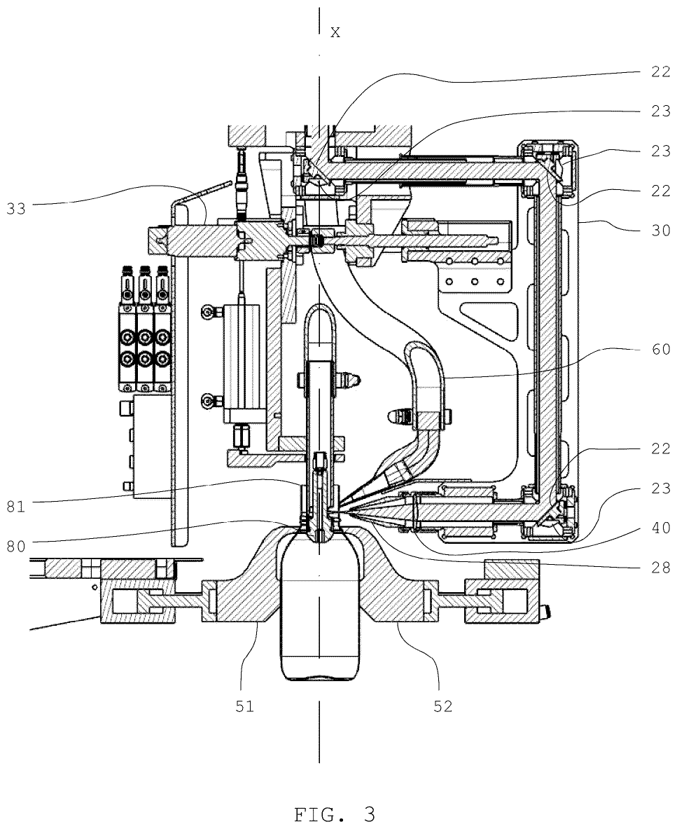

FIG. 3: is a detailed view from FIG. 2; and

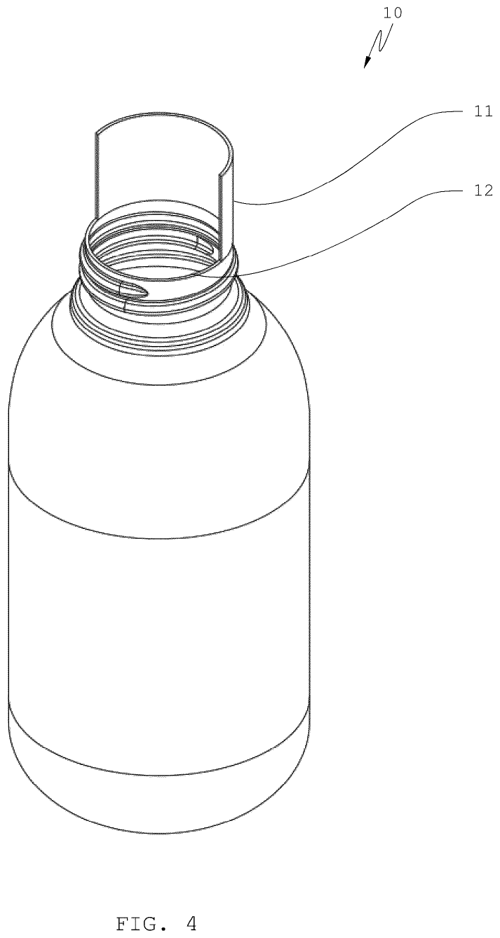

FIG. 4: is a perspective view of a fiber-based container.

FIG. 1 is a perspective view of a cutting device 100. The cutting device 100 comprises a holding device 50 for holding a fiber-based container 10. The cutting device 100 also comprises a cutting laser 20 which is immovably arranged on the cutting device 100 in this case. Above the fiber-based container 10, a support 32 is arranged on which a rotary bearing 31 is arranged. The support 32 can be moved vertically along the longitudinal axis X. The longitudinal axis X substantially corresponds to a longitudinal axis through the fiber-based container 10, and, in the case of a rotationally symmetrical fiber-based container 10, as shown here, the longitudinal axis X corresponds to the axis of rotation.

For the sake of improved clarity, feed devices for feeding the fiber-based containers 10 and for removing the fiber-based containers 10 are not shown.

FIG. 2 is a sectional view through the cutting device 100 according to FIG. 1. The cut extends transversely to the longitudinal extent of the laser 20 through the longitudinal axis X. The holding device 50 is arranged in the region of the cutting device 100 at the bottom in FIG. 2, by means of which holding device a fiber-based container 10 is held in the cutting device 100. Above the holding device 50, a vertically displaceable support 32 is arranged on which a rotary bearing 31 is arranged. A deflection device 30 for guiding the laser beam 21 is arranged on the rotary bearing 31. The laser beam 21 is generated by the laser 20. The laser beam 21 is generated in such a way that it is emitted substantially from the output side of the laser 20 in the direction of the longitudinal axis X. The laser beam 21 is deflected by means of the deflection device 30 so that it is substantially directed at a right angle to the fiber-based container 10. This will be explained in detail below with reference to FIG. 3. The rotary bearing 31 is arranged such that the deflection device 30 is movable about the longitudinal axis X, wherein the longitudinal axis X and the center of rotation lie substantially one above the other. In the present case, the deflection device comprises individual tubes 24, 25, 26 and 27, each of which is arranged at an angle to one another. At each of the interfaces of the individual tubes, deflection mirrors 23 for deflecting the laser beam 21 are arranged within the tubes. Their function will be explained below with reference to FIG. 3. The tube 24 of the deflection device 30 is variable in length so that the support can be moved vertically together with the rotary bearing 31 and the remaining elements of the deflection device 30. The tube 25 of the deflection device 30 is also variable in length so that a radial distance between the tubes 26 and 27 and the longitudinal axis X is adjustable.

FIG. 3 shows a detailed view of FIG. 2. As can be seen, a plurality of deflection mirrors 22 are arranged in the deflection device 30. Downstream in the direction of the laser beam, i.e. downstream in the direction of incidence, a safety element 23 is arranged for each deflection mirror 22, which in this case is designed as a metal plate. Focusing optics 40 for focusing the laser beam is also arranged on the deflection device 30 and an outlet nozzle 28 is arranged downstream in the direction of the beam. As explained in relation to FIG. 2, the radial distance of the deflection device, or the elements of the deflection device downstream of the rotary bearing 31, is adjustable. For this purpose, an actuator 33 is arranged below the rotary bearing 31. By operating the actuator 33, the distance between the focusing optics 40 and the longitudinal axis X is adjustable. This thus makes it possible to adjust a distance between the focal point of the laser beam 21 and the surface of the projection 11 to be separated (see FIG. 4).

In the present case, the deflection device 30 forms a substantially closed system into which a flushing gas can be introduced, which flows through the outlet nozzle 28 during operation. The holding device 50 is also visible in the illustration according to FIG. 3. Said holding device has two grippers 51 and 52 which hold a fiber-based container 10 from two sides. A flushing device 80 is introduced into the fiber-based container 10, by means of which a flushing gas can be introduced into the interior of the fiber-based container 10. During operation, or during the cutting process, the introduction of flushing gas can prevent dirt or dust particles from settling inside the fiber-based container 10. A second suction device 31 is formed integrally in the flushing device 80 and extracts the flushing gas introduced into the fiber-based container 10 together with any dirt particles it may contain above the fiber-based container or above an opening of the fiber-based container. A first suction device 60 is arranged outside the fiber-based container 10, specifically in the region of the outlet nozzle 28. The first suction device 60 extracts dirt and dust particles that form outside the fiber-based container, and at least some of the flushing gas from the deflection device 30 can be collected again.

The illustration in FIG. 3 shows the cutting device 100 during operation. Before this state is reached, the deflection device 30, the first suction device 60 and the flushing device 80 are arranged vertically above the fiber-based container. All these elements are collectively attached to the rotary bearing 31 and can be moved vertically with the support 32.

In order to separate an excess projection 11 of the fiber-based container 10 (see FIG. 4 in this regard), these aforementioned elements are moved in the vertical direction toward the fiber-based container 10, wherein during the vertical movement, the rotary bearing 31 together with the deflection device 30 and all elements arranged on the rotary bearing 31 begin to rotate about the longitudinal axis X. Likewise, as early as this point, the laser is started up so that it has already reached its preset power during the vertical displacement process and also during rotation and shoots through the fiber-based container 10 above the final cutting edge 12 (see FIG. 4 in this regard).

After reaching the final vertical position, the rotary bearing 31 is moved by a further 360° and then the support 33 is moved upward again in the vertical direction and the laser 20 is then switched off.

In FIG. 3, a protective plate is also shown opposite the outlet nozzle 28, which plate prevents the laser beam spreading uncontrollably in the event of a failure.

FIG. 4 is a perspective view of a fiber-based container 10. In the upper region, i.e. in the region of the neck, the fiber-based container 10 is shown cut so that the cutting edge 12 is visible. The cut therefore only extends through the excess projection 11. After the cutting process, the cutting edge 12 forms a final upper edge or upper opening of the fiber-based container 10, to which a corresponding lid can be attached.

After this processing step, the fiber-based container 10, which has now been manufactured, is supplied to further processing steps. For example, in a subsequent step, the interior of the fiber-based container 10 can be coated and/or the fiber-based container 10 can be fed to a filling system.

1. A cutting device (100) for manufacturing a fiber-based container (10), the cutting device (100) comprises a holding device (50) for holding the fiber-based container (10) and a cutting laser (20) for generating a laser beam (21), the laser beam (21) of the cutting laser (20) and the fiber-based container (10) being movable relative to one another in order to separate an excess projection (11) of the fiber-based container (10) by means of the laser beam (21).

2. The cutting device (100) according to claim 1, wherein the cutting device (100) has a rotary bearing (31), a deflection device (30) for guiding the laser beam (21) being arranged on the rotary bearing (31) so that the deflection device (30) is rotatable about a longitudinal axis (X) of the fiber-based container (10).

3. The cutting device (100) according to claim 1, wherein_the cutting device (100) has focusing optics (40) for focusing the laser beam (21), this focusing optics (40) being in particular an integral part of the deflection device (30).

4. The cutting device (100) according to claim 3, wherein the focusing optics (40) is arranged substantially at an angle of 85° to 95°, in particular at an angle of 89° to 91°, preferably perpendicularly, to a longitudinal axis (X) of the fiber-based container, and radially spaced therefrom.

5. The cutting device (100) according to claim 4, wherein a radial distance between the focusing optics (40) and the longitudinal axis (X) is adjustable, in particular continuously adjustable.

6. The cutting device (100) according to claim 1, wherein the laser beam (21) is guided through an outlet nozzle (28).

7. The cutting device (100) according to claim 2, wherein the deflection device (30) has a plurality of deflection mirrors (22), a safety element (23) being arranged downstream of each deflection mirror (22) in the direction of incidence.

8. The cutting device (100) according to claim 2, wherein the deflection device (30) is designed as a substantially closed system of individual tubes (24, 25, 26, 27).

9. The cutting device (100) according to claim 1, wherein a first suction device (60) for extracting vapors and dirt is arranged on the cutting device (30), in particular on a rotary bearing (31), the first suction device (60) ending in particular in the region of a outlet nozzle (28).

10. The cutting device (100) according to claim 1, wherein a flushing device (80) for flushing an interior of the container (10) with a flushing gas is arranged on the cutting device (100), in particular on the rotary bearing (31).

11. The cutting device (100) according to claim 10, wherein said device has a second suction device (81) for extracting the flushing gas from the interior of the container (10), the second suction device being designed in particular as a component of the flushing device (80).

12. The cutting device (100) according to claim 1, further comprising a holding device (50) has two grippers (51, 52).

13. The cutting device (100) according to claim 2, wherein the deflection device (30) is adjustable along the longitudinal axis (X).

14. A method for manufacturing a fiber-based container (10) using a cutting device, in particular a cutting device (100) according to claim 1, comprising the steps of:
providing a fiber-based container (10) in a holding device (50),
providing a laser beam (21) of a cutting laser (20),
separating an excess projection (11) of the fiber-based container (10) by means of the laser beam (21),
wherein
the fiber-based container (10) and the laser beam (21) are moved relative to one another in order to separate the excess projection (11).

15. The method according to claim 14, further comprising guiding the laser beam (21) in a deflection device (30) and rotating said device about a longitudinal axis (X) of the fiber-based container (10) in order to separate the excess projection (11).

16. The method according to claim 14, further comprising focusing the laser beam (21) by means of focusing optics (40) to a certain distance from the surface of the excess projection (11) to be separated.

17. The method according to claim 14, wherein the laser beam (21) is positioned and activated in the direction of the longitudinal axis (X) above a final cutting surface (12) and the laser cut has a vertical movement component up to a cutting position of the final cutting surface (12).

18. The method according to claim 14, wherein after completion of the cut of the final cutting surface (12), the laser beam (21) is moved in the direction of the longitudinal axis (X) over the final cutting surface (12) before the laser beam (21) is deactivated and the laser cut has a vertical movement component up to the final position in which the laser beam (21) is deactivated.

19. The method according to claim 14, wherein a radial distance between focusing optics (40) and the longitudinal axis (X) is initially adjusted according to a container-specific parameter.

20. The method according to claim 19, wherein the container-specific parameter is determined individually for each fiber-based container (10).

21. The method according to claim 19, wherein the radial distance is continuously adapted to a contour of the fiber-based container (10) during the separation process.

22. The method according to claim 14, wherein during the separation process, flushing gas is blown into the fiber-based container (10) by a flushing device (80).

23. The method according to claim 14, wherein during the separation process, exhaust air is extracted from the fiber-based container (10) by means of a second suction device (81) and/or from the region of an outlet nozzle (28) by means of a first suction device (60).

24. The method according to claim 15, wherein_during the separation process, the deflection device (30) is supplied with flushing gas.

25. The method according to claim 14, wherein after the separation process, the separated excess projection (11) is stripped off the cutting device by means of a stripping ring (82).
